(19) United States
(12) Patent Application Publication
(10) Pub. No.: US 2010/0278163 A1
(43) Pub. Date: Nov. 4, 2010

(54) METHOD OF DELIVERING DATA IN WIRELESS PRESONAL AREA NETWORK

(76) Inventors: In-Hwan Lee, Seoul (KR); Bong-Soo Kim, Daejeon-city (KR); Cheol-Sig Pyo, Daejeon-city (KR); Jong-Suk Chae, Daejeon-city (KR); Sung-Rae Cho, Daejeon-city (KR)

Correspondence Address: STAAS & HALSEY LLP, SUITE 700, 1201 NEW YORK AVENUE, N.W., WASHINGTON, DC, 20005, US

(21) Appl. No.: 12/808,330

(22) PCT Filed: Sep. 8, 2008
(86) PCT No.: PCT/KR2008/005277

§ 371 Date: Jun. 15, 2010

(30) Foreign Application Priority Data
Dec. 17, 2007 (KR) 10-2007-0132705

(51) Int. Cl. H04W 4/00

(52) U.S. Cl. 370/338

(57) ABSTRACT

Provided is a method of delivering data in a wireless personal area network. One of nodes forming the wireless personal area network broadcasts data including the address and the sequence number of one node to a plurality of other nodes, and broadcasts one of the data and other data to the other nodes depending on whether the data is received from the other nodes within a predetermined time. Accordingly, all the nodes on the network can receive data reliably and simultaneously power consumption is reduced, and thus the life of the network is extended.

### CROSS-REFERENCE TO RELATED PATENT APPLICATION

This application claims the benefit of Korean Patent Application No. 10-2007-0132705, filed on Dec. 17, 2007, in the Korean Intellectual Property Office, the disclosure of which is incorporated herein in its entirety by reference.

### BACKGROUND OF THE INVENTION

1. Field of the Invention

The present invention relates to a method of delivering data in a wireless personal area network, and more particularly, to a method that can reliably deliver data from one node to other nodes forming a wireless mesh personal area network while consuming minimum power.

The present invention is derived from a research project supported by the Information Technology (IT) Research & Development (R&D) program of the Ministry of Information and Communication (MIC) and the Institute for Information Technology Advancement (IITA) [2005-S-038-03, Development of Sensor Tag and Sensor Node Technologies for RFID/USN].

2. Description of the Related Art

As a ubiquitous age arrives, lots of researches on a wireless personal area network that can be easily used any time are in progress. Though services of various purposes can be provided through a wireless personal area network having characteristics of low power and low speed, the wireless personal area network has inconvenience that there is a limit in a communication distance. Therefore, lots of researches are being carried out to form a wireless personal area network in a mesh configuration connecting nodes to each other and thus extend the communication region of the wireless personal area network.

Since connection between nodes is formed through a plurality of paths when the wireless personal area network is formed in the mesh configuration, power consumption between nodes can be minimized. However, in case of having to transmit, at each node, the same information as in software update and important routing information sharing through a mesh network using a broadcast method, reliability of data transmission should be guaranteed in the first place, but the reliability has not been secured frequently. Meanwhile, to reliably transmit data, a unicast transmission method has used a method of transmitting an NACK message to a transmission node when an error occurs and transmitting an ACK message to the transmission node when an error does not occur depending on whether an error occurs in transmitted data at a reception node receiving data during a data transmission operation, so that the transmission node can retransmit data.

FIG. 1 is a view illustrating data collision occurring when data are delivered using a broadcast method in the case where a wireless personal area network is formed in a mesh configuration.

When a transmission node 100 delivers data using a broadcast method and a reception node that has received data transmits an ACK/NACK message to the transmission node 100, data collision occurs as illustrated in FIG. 1.

That is, when the construction of receiving an ACK/NACK message in order to reliably transmit data in the unicast transmission method is applied to the broadcast method, numerous collisions occur in a lower layer and serious power consumption is generated due to the collisions. Accordingly, the broadcast transmission method cannot be used to guarantee reliability.

Therefore, the present invention is directed to a method of reliably delivering data from one node to other nodes forming a wireless personal area network while consuming minimum power.

### SUMMARY OF THE INVENTION

According to an aspect of the present invention, there is provided a method of delivering data in a wireless personal area network, the method including: broadcasting data including an address and a sequence number of one node to a plurality of other nodes forming the wireless personal area network; and broadcasting one of the data and other data to the other nodes depending on whether the data is received from the other nodes within a predetermined time.

According to another aspect of the present invention, there is provided a method of delivering data in a wireless personal area network, the method including: receiving data including an address and a sequence number of a node that has transmitted data; broadcasting the received data to other nodes; and broadcasting one of the data and other data to the other nodes depending on whether the data is received from the other nodes within a predetermined time.

According to another aspect of the present invention, there is provided a computer readable recording medium having recorded thereon a program for executing on a computer a method of recognizing positions of a plurality of nodes forming a wireless sensor network.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating data collision occurring when data are delivered using a broadcast method in the case where a wireless personal area network is formed in a mesh configuration;

FIG. 2 is a flowchart illustrating a method of delivering data in a wireless personal area network according to an embodiment of the present invention;

FIG. 3 is a view of a transaction table managed by nodes forming a wireless personal area network according to an embodiment of the present invention; and

FIG. 4 is a flowchart illustrating a method of delivering data in a wireless personal area network according to another embodiment of the present invention.

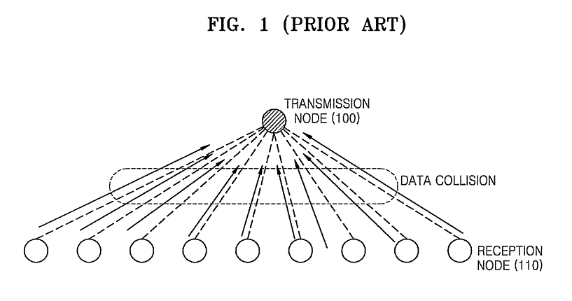

### DETAILED DESCRIPTION OF THE INVENTION

The present invention will now be described more fully with reference to the accompanying drawings, in which exemplary embodiments of the invention are shown.

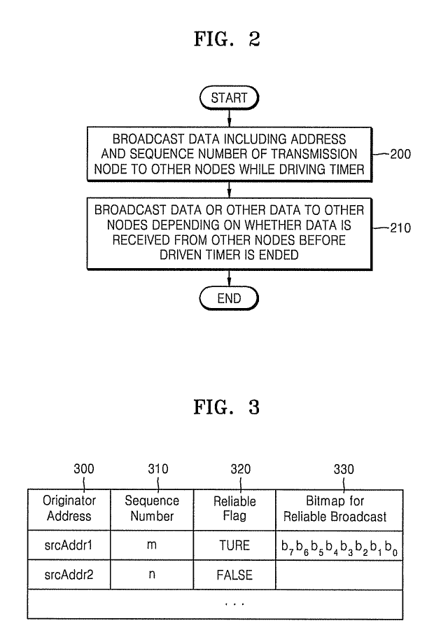

FIG. 2 is a flowchart illustrating a method of delivering data in a wireless personal area network according to an embodiment of the present invention. Nodes forming the wireless personal area network deliver data to other nodes. Hereinafter, a process of delivering data from one transmission node forming the wireless personal area network to other nodes will be described with reference to FIG. 2.

In operation 200, data including the address and the sequence number of a transmission node are broadcasted to other nodes while a timer is driven. Here, the time is driven to know whether a predetermined time elapses. In the case where a transmission node, which is one of nodes forming a wireless personal area network, intends to deliver data to other nodes forming the wireless personal area network as described above, the transmission node broadcasts data including the address and the sequence number of the transmission node to the other nodes. At this point, the sequence number is a number generated by the transmission node to discriminate data transmitted from the transmission node to the other nodes. The sequence number is increased by “1” whenever data is generated, and included in the data. Since data transmitted to other nodes sequentially include different sequence numbers, respectively, according to a transmission sequence, nodes receiving data can identify the kind and sequence of data through the sequence number. Also, the transmission node manages a transaction table including the address of the transmission node, the sequence number, a reliability flag, and a bitmap.

FIG. 3 is a view of a transaction table managed by nodes forming a wireless personal area network according to an embodiment of the present invention.

That is, as illustrated in FIG. 3, a transmission node manages a transaction table including an address of the transmission node 300, a sequence number 310, a reliability flag 320, and a bitmap 330. Also, the transaction table is managed by not only the transmission node but also other nodes forming the wireless personal area network. The address of the transmission node 300 on the transaction table is the address of a node that has transmitted data, the sequence number 310 is a value used for discriminating data delivered to other nodes, the reliability flag 320 informs whether data has been broadcasted reliably or unreliably, and the bitmap 330 informs whether broadcast data has been delivered to other nodes. At this point, when the reliability flag is set to “TRUE”, it means that data has been broadcasted reliably. When the reliability flag is set to “FALSE”, it means that data has been broadcasted unreliably. The terms “reliably/unreliably” means whether data has been delivered to a node successfully or not. Also, since bitmaps correspond to neighboring nodes located in the neighborhood of a transmission node, the number of the bitmaps coincides with the number of the neighboring nodes. At this point, the neighboring nodes mean nodes located at a distance of 1 hop from the transmission node in general. Here, the bitmap values are initialized to “0”.

Referring to FIG. 2 again, in operation 210, one of the data and other data is broadcast to other nodes depending on whether the data is received from other nodes before the driven timer is ended. In operation 200, the transmission node broadcasts data and simultaneously drives the timer according to an embodiment. Then, the transmission node broadcasts the data or other data to other nodes depending on whether the data is received from the other nodes before the driven timer is ended. That is, when receiving the data from all of the other nodes before the driven timer is ended, the transmission node broadcasts other data to the other nodes. When receiving data from only some of the other nodes, the transmission node broadcasts again the data to the other nodes.

More specifically, when receiving the data before the driven timer is ended, the transmission node sets a bitmap value corresponding to a node that is a source of the received data to “1”. On the other hand, when not receiving the data before the driven timer is ended, the transmission node sets a bitmap value corresponding to a node that is a source of the not received data to “0”. That is, the transmission node that has broadcasted data receives the broadcasted data according to an embodiment of the present invention. When receiving the data within a predetermined time, the transmission node sets only a bitmap value corresponding to a node that has transmitted the received data to “1”. A bitmap value included in the transaction table and managed by the transmission node is set to “1” or “0” through the above process. The value of “1” means that data has been delivered from the transmission node to a node corresponding to the bitmap set to “1”, and the value of “0” means that data has not been delivered from the transmission node to a node corresponding to the bitmap set to “0”. Therefore, the received data performs a reception acknowledge (ACK) function.

When all of bitmap values on the transaction table are set to “1”, it means that data has been delivered from the transmission node to all of other nodes. Therefore, the transmission node broadcasts other data besides the initially broadcasted data. The newly broadcasted other data includes a sequence number increased by “1” compared to that of the initially broadcasted data.

On the other hand, when any one of bitmap values on the transaction table is set to “0”, it means that data has not been delivered to all of the other node, the transmission node broadcasts again the initially broadcasted data. Since the transmission node can reliably broadcast data through this process, the data can be delivered to the other nodes.

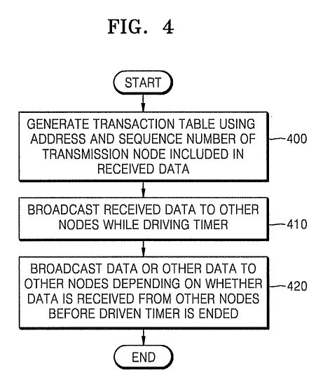

FIG. 4 is a flowchart illustrating a method of delivering data in a wireless personal area network according to another embodiment of the present invention. Nodes forming a wireless personal area network can deliver data received from a transmission node to other nodes. A process of delivering, at a reception node, data received from a transmission node to other nodes will be described below.

In operation 400, a transaction table is generated using the address and the sequence number of the transmission node included in the received data. The reception node that has received the data from the transmission node generates and manages the transaction table illustrated in FIG. 3 using the address and the sequence number of the transmission node included in the data.

In operation 410, the received data is broadcasted to other nodes while a timer is driven. That is, the reception node broadcasts the received data including the address and the sequence number of the transmission node to other nodes. As described above, the reception node broadcasts the data delivered from the transmission node to the other nodes so that the data may be delivered to all of the other nodes forming the wireless personal area network.

In operation 420, the data or other data are broadcasted to the other nodes depending on whether the data is received from the other nodes before the driven timer is ended. That is, the reception node broadcasts one of the data and other data to the other nodes depending on whether the data is received from the other nodes before the driven timer is ended. When receiving the data before the driven timer is ended, the reception node sets a bitmap value corresponding to a node that is a source of the received data to “1”. On the other hand, when not receiving the data before the driven timer is ended, the reception node sets a bitmap value corresponding to a node that is a source of the not received data to “0”.

Also, when all of the bitmap values on the transaction table are set to “1”, other data different from the initially broadcasted data is broadcasted. When any one of bitmap values on the transaction table is set to “0”, the initially broadcasted data is broadcasted again. That is, when the broadcasted data is delivered to all of the other nodes, the other data is broadcasted. When the broadcasted data is not delivered to all of the other nodes, the initially broadcasted data is broadcasted again so that the data is delivered to all of the nodes. As described above, since receiving the broadcasted data means that the data has been received, the received data performs a reception ACK function.

In the method of delivering data in the wireless personal area network according to the present invention, data including an address and a sequence number of one node are broadcasted from one of nodes forming the wireless personal area network to a plurality of other nodes, and one of the data and other data is broadcasted to the other nodes depending on whether the data are received from the other nodes within a predetermined time, so that all nodes on the network can reliably receive data and power consumption can be reduced and thus the life of the network can be extended.

The embodiments of the present invention can be written as computer programs and can be implemented in general-use digital computers that execute the programs using a computer readable recording medium.

A data structure used for the above-described embodiments of the present invention can be recorded on a computer readable recording medium using various elements.

Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of delivering data from one node to a plurality of other nodes forming a wireless personal area network, the method comprising:
broadcasting data including an address and a sequence number of the one node to the plurality of other nodes; and
broadcasting one of the data and other data to the other nodes depending on whether the data is received from the other nodes within a predetermined time.

2. The method of claim 1, wherein the broadcasting of the one of the data and the other data to the other nodes comprises:
setting bitmap values corresponding to the other nodes depending on whether the data is received from the other nodes within the predetermined time; and
broadcasting one of the data and the other data to the other nodes depending on the set bitmap values.

3. The method of claim 2, wherein the setting of the bitmap values comprises setting bitmap values corresponding to nodes that are sources of the received data to “1” when receiving the data within the predetermined time, and setting bitmap values corresponding to the others to “0”.

4. The method of claim 3, wherein the broadcasting of the one of the data and the other data to the other nodes depending on the set bitmap values comprises broadcasting the other data when all of the set bitmap values are “1”, and broadcasting again the data when any one of the set bitmap values is “0”.

5. The method of claim 1, wherein the data and the other data are discriminated from each other using a sequence number included in data.

6. The method of claim 1, wherein the broadcasting of the one of the data and the other data to the other nodes comprises:
broadcasting the other data to the other nodes when the data is received from all of the other nodes within the predetermined time; and
broadcasting again the data to the other nodes when the data is received from only some of the other nodes within the predetermined time.

7. A method of delivering data at a node forming a wireless personal area network, the method comprising:
receiving data including an address and a sequence number of a node that has transmitted data;
broadcasting the received data to other nodes; and
broadcasting one of the data and other data to the other nodes depending on whether the data is received from the other nodes within a predetermined time.

8. The method of claim 7, wherein the broadcasting of the one of the data and the other data comprises:
setting bitmap values corresponding to the other nodes depending on whether the data is received from the other nodes within the predetermined time; and
broadcasting one of the data and the other data to the other node depending on the set bitmap values.

9. The method of claim 8, wherein the setting of the bitmap values comprises:
setting bitmap values corresponding to nodes that are sources of the received data to “1” when receiving the data within the predetermined time, and setting bitmap values corresponding to the others to “0”.

10. The method of claim 9, wherein the broadcasting of the one of the data and the other data to the other nodes depending on the set bitmap values comprises broadcasting the other data when all of the set bitmap values are “1”, and broadcasting again the data when any one of the set bitmap values is “0”.

11. The method of claim 7, wherein the data and the other data are discriminated from each other using a sequence number included in data.

12. The method of claim 7, wherein the broadcasting of the one of the data and the other data to the other nodes comprises:
broadcasting the other data to the other nodes when the data is received from all of the other nodes within the predetermined time; and
broadcasting again the data to the other nodes when the data is received from only some of the other nodes within the predetermined time.
